(19) United States
(12) Patent Application Publication
(10) Pub. No.: US 2023/0415169 A1
(43) Pub. Date: Dec. 28, 2023

(54) A CENTRIFUGAL SEPARATOR FOR CLEANING GAS

(71) Applicant: Alfdex AB, LANDSKRONA (SE)

(72) Inventor: Mats-Örjan POGÉN, BILLEBERGA (SE)

(73) Assignee: Alfdex AB, LANDSKRONA (SE)

(21) Appl. No.: 18/036,756

(22) PCT Filed: Nov. 2, 2021
(86) PCT No.: PCT/EP2021/080336

§ 371 Date: May 12, 2023

(30) Foreign Application Priority Data
Nov. 30, 2020 (EP) 20210561.5

(51) Int. Cl. B04B 5/12; B04B 5/00; B04B 7/04

(52) U.S. Cl. CPC B04B 5/12; B04B 2005/125; B04B 7/04; B04B 5/005

(57) ABSTRACT

A centrifugal separator for cleaning gas containing contaminants includes a stationary casing, a gas inlet, a rotating member including a plurality of separation members, a gas outlet, a drainage outlet arranged in the lower portion of the stationary casing and a drive member for rotating the rotating member. The axial inner side surface of the stationary casing incudes at least one straight recess extending in the axial direction for accumulating oil that has been separated in the plurality of separation members. The at least one recess includes a first radial recess surface extending from the axial inner side surface of the stationary casing. The at least one recess extends axially on the inner side surface at least along the axial length of the radially outermost portion of the separation members.

### FIELD OF THE INVENTION

The present invention relates to the field of centrifugal separators for cleaning a gas containing liquid contaminants. In particular, the present invention relates to cleaning crankcase gases of a combustion engine from oil particles.

### BACKGROUND OF THE INVENTION

It is well known that a mixture of fluids having different densities may be separated from one another through use of a centrifugal separator. One specific use of such a separator is in the separation of oil from gas vented from a crankcase forming part of an internal combustion engine.

With regard to this specific use of separators, there can be a tendency for the high-pressure gas found in the combustion chambers of an internal combustion engine to leak past the associated piston rings and into the crankcase of the engine. This continuous leaking of gas into the crankcase can lead to an undesirable increase of pressure within the crankcase and, as a consequence, to a need to vent gas from the casing. Such gas vented from the crankcase typically carries a quantity of engine oil (as droplets or a fine mist), which is picked up from the reservoir of oil held in the crankcase.

In order to allow vented gas to be introduced into the inlet system without also introducing unwanted oil (particularly into a turbocharging system wherein the efficiency of the compressor can be adversely affected by the presence of oil), it is necessary to clean the vented gas (i.e. to remove the oil carried by the gas) prior to the gas being introduced into the inlet system. This cleaning process may be undertaken by a centrifugal separator, which is mounted on or adjacent the crankcase and which directs cleaned gas to the inlet system and directs separated oil back to the crankcase. An example of such a separator is disclosed e.g. in U.S. Pat. No. 8,657,908.

Such separators usually comprise a number of separation discs, e.g. arranged in a stack or as axially extending surface plates, and the separation of oil from the gas takes place between such discs, in which oil being collected on the disc is thrown radially outwards to a surrounding wall. However, droplets from accumulated oil on the wall may be ripped off by the turbulence of the cleaned gas and may thus again re-enter the cleaned gas to the clean gas outlet.

There is thus a need in the art for improved solutions for decreasing the risk of separated oil re-entering the cleaned gas in centrifugal separators.

EP 3441145 discloses a centrifugal separator with a corrugated inner surface with alternating ditches and ridges.

EP 2020485 discloses a centrifugal separator having helical guiding recesses on an insert of the separation space.

### SUMMARY OF THE INVENTION

It is an object of the invention to at least partly overcome one or more limitations of the prior art. In particular, it is an object to provide a centrifugal separator with decreased risk of separated oil re-entering clean gas.

As a first aspect of the invention, there is provided a centrifugal separator for cleaning gas containing contaminants comprising
a stationary casing, enclosing a separation space through which a gas flow is permitted,
a gas inlet extending through the stationary casing and permitting supply of the gas to be cleaned,
a rotating member comprising a plurality of separation members arranged in the separation space and being arranged to rotate around an axis (X) of rotation,
a gas outlet arranged in the upper portion of the stationary casing and configured to permit discharge of cleaned gas and comprising an outlet opening through a wall of the stationary casing,
a drainage outlet arranged in the lower portion of the stationary casing and configured to permit discharge of liquid contaminants separated from the gas to be cleaned;
a drive member, for rotating the rotating member;
and wherein an axial inner side surface of the stationary casing comprises at least one straight recess extending in the axial direction for accumulating oil that has been separated in the plurality of separation members. Further, the at least one recess comprises a first radial recess surface extending from the axial inner side surface of the stationary casing, and wherein the at least one recess extends axially on the inner side surface at least along the axial length of the radially outermost portion of said separation members.

As used herein, the term “axially” denotes a direction which is parallel to the rotational axis (X). Accordingly, relative terms such as “above”, “upper”, “top”, “below”, “lower”, and “bottom” refer to relative positions along the rotational axis (X). Correspondingly, the term “radially” denotes a direction extending radially from the rotational axis (X). A “radially inner position” thus refers to a position closer to the rotational axis (X) compared to “a radially outer position”.

The contaminants in the gas may comprise liquid contaminants, such as oil, and soot.

Consequently, the centrifugal separator may be for separating liquid contaminants, such as oil, from gas. The gas may be crankcase gas of a combustion engine. However, the centrifugal separator may also be suitable for cleaning gases from other sources, for instance the environment of machine tools which frequently contains large amounts of liquid contaminants in the form of oil droplets or oil mist.

The stationary casing of the centrifugal separator may comprise a surrounding side wall, and first and second end walls, which enclose the separation space. The stationary casing may have a cylindrical shape with circular cross-section having a radius R from the axis (X) of rotation to the surrounding side wall. This radius R may be constant at least with respect to a major part of the circumference of the surrounding side wall. The stationary casing may also be slightly conical. The first and second end walls may thus form an upper end wall and a lower end wall of the cylindrical shaped casing.

The gas inlet of the centrifugal separator may be arranged through the first end wall or through the surrounding side wall close to the first end wall, thus at the top of the separator, such that gas entering through the gas inlet is directed to the separation space. The gas inlet may be arranged around the axis of rotation (X).

The drainage outlet is arranged in the lower portion of the stationary casing, such as arranged in the second end wall, e.g. at the bottom of the separator. Thus, the drainage outlet may be arranged centrally in an end wall opposite the end wall through which, or at which, the inlet is arranged. The drainage outlet of the centrifugal separator may further be formed by several spot shaped through holes of the stationary casing or by a single drainage passage. The drainage outlet may be arranged at the axis of rotation or centered on the axis of rotation. The drainage outlet may also be in an annular collection groove at the inner end wall of the stationary casing.

The gas outlet is arranged in an upper portion of the stationary casing, such as in the upper portion of a surrounding side wall of the stationary casing or arranged in an upper end wall of the stationary casing.

The rotating member is arranged for rotation during operation by means of the drive member. The rotating member comprises a plurality of separation members arranged in the separation space. The separation members of the rotating member are examples of surface-enlarging inserts that promote separation of contaminants from the gas. The separation members may be a stack of separation discs. The separation discs of the stack may be frustoconical. A frustoconical disc may have a planar portion extending in a plane that is perpendicular to the axis of rotation, and a frustoconical portion that may extend upwards or downwards. The planar portion may be closer to the rotational axis than the frustoconical portion. Further, the discs of the stack may be radial discs, in which substantially the whole disc extends in a plane that is perpendicular to the axis of rotation.

During operation, gas to be cleaned may be directed centrally through the plurality of separation members, such as centrally through the stack of separation discs. In such a set-up, the rotating member may further define a central space formed by at least one through hole in each of the separation members. This central space is connected to the gas inlet and configured to convey the gas to be cleaned from the gas inlet to the interspaces between the separation members, such as between the interspaces between the discs of a stack of separation discs. A separation disc that may be used as separation member may comprise a central, essentially flat portion perpendicular to the axis of rotation. This portion may comprise the through holes that form parts of the central space.

Thus, the centrifugal separator may be configured to lead gas to be cleaned, such as crankcase gases, from the gas inlet into a central portion of the rotating member. In this manner the crankcase gases may be “pumped” from the central portion of the rotating member into the interspaces between the separation discs in the stack of separation discs by the rotation of the rotating member. Thus, the centrifugal separator may work according to the concurrent flow principle, in which the gas flows in the disc stack from a radial inner part to a radial outer part, which is opposite to a separator operating according to the counter-current flow principle, in which the gas is conducted into the centrifugal rotor at the periphery of the rotor and is led towards a central part of the rotor.

The drive member may for example comprise a turbine wheel, rotated by means of an oil jet from the lubrication oil system of the combustion engine or a free jet wheel comprising a blow-back disk. However, the drive member may also be independent of the combustion engine and comprise an electrical motor, a hydraulic motor or a pneumatic motor.

It is also to be understood that the separation members, such as separation discs, not necessarily have to be arranged in a stack. The separation space may for example comprise axial discs, or plates that extend around the axis of rotation. The axial discs or plates may be planar, i.e. extending in planes that are parallel to the axis of rotation. The axial discs or plates may also have a slightly or significantly curved shape, such as an arcuate or spiral shape, as seen in a radial plane.

Further, according to the first aspect, an inner axial side surface of the stationary casing comprises at least one straight recess extending in the axial direction for accumulating oil that has been separated in the plurality of separation members.

The at least one recess refers to a one or several straight ditches in the inner surface that extend in the axial direction, i.e. in the vertical direction if the rotational axis extends vertically. The recess or recesses are thus arranged in the inner surface of the surrounding sidewall that is hit by the separated gas after separation in the plurality of separation members.

Each recess may be straight and extend in a direction that forms only a small angle with the axis of rotation (X), such as forming an angle that less than 45 degrees, such as less than 30 degrees, such as less than 20 degrees, such as less than 10 degrees with the axis of rotation.

Thus, the at least one recess may be straight and extend in a direction that is parallel to the rotational axis (X).

Further, the at least one straight recess comprises a first radial recess surface extending from the axial inner side surface. A radial recess surface extends into the axial inner side surface substantially in the radial direction. The normal to the radial recess surface is thus substantially perpendicular to the radial direction.

Further, the at least one recess extends axially on the inner side surface at least along the axial length of the radially outer distance of the separation members, i.e. at least along the axial length of the radially outermost portion of the separation members.

The first aspect of the invention is based on the insight that at least one recess on the inner surface that extend in the axial direction, the oil film formed on the inner surface after separation from the gas will have a calm area to accumulate and be pulled axially down, e.g. by aid of gravity, towards the drainage outlet. The recesses thus decreases the risk of the rotating gas pulling separated oil droplets from the film into the cleaned gas.

Moreover, in recesses, the assembled oil experiences a calmer environment compared to guiding members in the form of protrusions or ribs protruding from the inner surface of the stationary casing. On such protrusions, oil may be gathered and then break free due to the circulating gas stream, which is thus avoided by the use of the recesses in the centrifugal separator of the first aspect.

Further, due to the radial recess surface, oil in the recess has a deceased risk of being pulled out from the inner surface as compared to e.g. if the ditch has inner side surfaces that form a corrugated pattern. In other words, it has been found that a radial recess surface gives the calmest environment for the separated oil. Also, the at least one recess extends along the axial length of radially outer distance of the separation members, which is advantageous in that it allows for collecting al oil more or less immediately in the recess once separated and thrown against the inner axial wall by the centrifugal force from the separation members.

Moreover, since the at least one recess is straight and provided directly on the inner side surface of the stationary casing, no inserts with guiding means for the separated oil is needed, i.e. it facilitates production. The straight recess also provides for easy manufacturing a larger number of recesses compared to prior art in which helical recesses may be used.

Consequently, the first aspect of the invention provides for a higher cleaning efficiency of the centrifugal separator.

A recess is to be understood as a thin ditch extending in the axial direction. Thus, the circumferential extension between recesses may be larger than the circumferential extension of a single recess

Further, compared to the total inner area of the sidewall of the casing, the area of the recesses is small. Consequently, in embodiments of the first aspect, the inner area of the at least one recess is less than half of the area of the total axial inner side surface of the stationary casing.

In embodiments of the first aspect, at least one, such as all recesses, have a substantially constant width throughout the axial length of the recess. As an alternative at least one recess, such as all recesses, may have a different width at an axial upper portion as compared to an axial lower portion of a recess. For example, at least one recess, may be wider at an upper portion of a recess. As a further example, at least one recess may be wider at a lower portion of the recess.

As an example, a recess may have a width that is less than 25 mm, such as less than 20 mm, such as equal or less than 15 mm, such as equal or less than 10 mm.

In embodiments of the first aspect, the inner side surface of the stationary casing comprises at least three recesses, such as at least five recesses.

As an example, the inner surface may comprise less than 20 recesses, such as less than 10 recesses. As an example, the inner surface may comprise between 2-8 recesses, such as between 3-6 recesses.

A centrifugal separator according to any previous claim, wherein the at least one recess extends axially down to the bottom of the stationary casing.

Thus, oil may be guided in the recesses all the way down to the bottom portion of the inner wall, such that separated oil is guided in the recesses all the way down to the bottom end wall. Oil may then flow on the inner surface of the bottom end wall from the axial bottom end of the recesses to the drainage outlet, which also may be arranged in the bottom end wall.

In embodiments of the first aspect, the plurality of separation members is a stack of separation discs. Then, the at least one recess extend axially on the inner side surface of the stationary casing at least along the axial length of the radially outer distance of the disc stack.

Thus, the at least one recess may extend on the inner side surface from an upper axial position X1 that is at or above the upper axial position Y1 of the radial outermost portion of the disc stack down to a lower axial position X2 that is at or below the lowest axial position Y2 of the radial outermost portion of the disc stack.

The at least one recess may extend axially along the whole axial length of the axial inner side surface. Consequently, in embodiments of the first aspect, the at least one recess extends axially from the top to the bottom of the axial inner side surface.

In embodiments of the first aspect, the centrifugal separator comprises a plurality of recesses. Such plurality of recesses may comprise recesses of different axial lengths. As an example, an axial lower portion of the axial inner surface of the stationary casing may comprise wider and/or a larger amount of recesses as compared to an axial upper portion of the axial inner surface. Consequently, the centrifugal separator may comprise a first set of recesses extending only in the axial lower portion of the axial inner surface of the stationary casing and a second set of recesses extending in both an axial lower portion and an axial upper portion of the stationary casing.

The cross section of the at least one recess as seen in a radial plane may for example be substantially rectangular or quadratic. Thus, the actual recess may have the form of a cuboid or rectangular prism. However, other shapes of the recess are also possible. In embodiments of the first aspect, the at least one recess has a tip-shaped cross-section as seen in a radial plane such that the cross-section of the recess tapers from a radial inner position to a radial outer position.

Thus, the at least one recess may have a triangular cross-section as seen in the radial plane, i.e. the recess may have the form of a triangular prism. For example, the tip-shaped cross-section of the recess may be formed by a first radial recess surface extending from the axial inner side surface of the stationary casing and a second recess surface forming an angle with the radial direction. The “tip” of the triangular cross section is thus where these first and second recess surfaces meet at the radially innermost position of the cross-section.

The axial inner surface of the stationary casing may be substantially flat apart from the at least one recess.

In embodiments of the first aspect, the axial inner side surface comprises at least one rib extending axially alongside the at least one recess.

Such rib may aid in gathering oil into the recess and provide a larger protection and thus a calmer environment for the oil that is guided within the recess. Thus, such a rib may decrease the oil from being dragged out from the recess by the circulating gas during operation of the centrifugal separator. For example, if large amounts of oil is separated out from the gas such that a recess is about to overflow, an adjacent rib may prevent such overflowing oil from being detached from the inner surface.

The rib may thus axially adjacent to part of, or the whole, axial length of the at least one recess.

The at least one rib may extend axially adjacent to the first radial recess surface, such as axially along the whole length of the first radial recess surface.

The rib is a protrusion of the inner side surface of the stationary casing. Such ribs may aid in directing the oil into the recesses. There may be one rib for each recess extending along an axial side of the recess. A rib may extend axially adjacent to a recess such that a recess surface abuts a surface forming the rib.

As an example, the first radial recess surface also forms a portion of the rib.

Thus, the first radial recess surface may extend out from the axial inner side surface and for a portion of the rib that is arranged alongside the at least one recess.

As an example, the at least one rib may be arranged such that the first radial recess surface also forms part a protruding tip of the rib.

Also, the rib may have a rectangular, quadratic or triangular cross-section as seen in the radial plane. Thus, the rib may have the form of a rectangular, quadratic or triangular prism extending on the inner side surface of the casing. As an example, the rib may have a tip-shaped cross-section with the tip being arranged closest to the recess.

As an example, a rib and adjacent recess may form a Z-shaped cross-section in a radial plane. Consequently, a radial recess surface may also protrude from the inner surface of the stationary casing, thereby forming part of the recess. Such radial surface may form the middle portion of the Z-shaped cross section in a radial plane.

In embodiments of the first aspect, the gas inlet is arranged at the upper portion of the stationary casing. Thus, the gas inlet may be arranged in an upper end wall or in an upper portion of a side wall of the stationary casing.

Further, as discussed above, the plurality of separation members may be a stack of separation discs, such as frustoconical separation discs. Such discs may have an outer radius and an inner radius, thus forming a central opening in the disc. The stack of such discs may thereby form a central space radially within the inner radius of the discs. The gas to be cleaned may be guided into this central space and then to the interspaces formed between the discs in the disc stack.

Consequently, in embodiments of the first aspect when the gas inlet is arranged at the upper portion of the stationary casing and when the plurality of separation members is a stack of separation discs, the gas inlet may be arranged to guide the gas into the central space of the disc stack axially from above, and the centrifugal separator may comprise a guiding member for guiding the gas, liquid oil and larger aerosols from the central portion of the stack to the interspaces between the discs of the disc stack at an axial entry position that is below the uppermost axial position of the disc stack.

The inventor has found that when gas to be cleaned is entering the disc stack mainly via the upper portions of the disc stack, liquid oil and larger aerosols may be centrifuged out from the top of the stack whereas the gas is more evenly distributed in the disc stack. This is more evident at so called “oil shock”, in which gas containing large amount of oil is led to the gas inlet. Further, when the gas outlet is arranged at the upper portion of the disc stack, there is a risk that such oil being centrifuged out from the upper separation discs follows the cleaned gas to the gas outlet instead of flowing downwards. By introducing a guiding member that distributes the gas to be cleaned down to a position that is below the uppermost inner axial position of the separation discs to a more central portion of the disc stack, such risk of oil being led out via the gas outlet may be decreased. Thus, with the aid of a guiding member, liquid oils and aerosols in the gas may be guided in a middle and lower portion of the disc stack, whereas the gas is more evenly distributed in the disc stack. This also means that oil is separated out into a lower portion of the inner surface of the stationary casing and thus closer to the oil outlet.

Further, the distribution of gas may be more even over the axial length of the disc stack if the gas is guided to enter the interspaces of the disc stack in a central portion of the disc stack and not in one axial end of the disc stack.

As an example, the guiding member is arranged to guide the gas at an axial entry position that is below the upper 25% of the total axial length of the disc stack, such as below the upper 40% of the total axial length of the disc stack

The total axial length thus refers to the total axial length of the central portion formed within the inner radius of the discs.

As an example, the guiding member may be in the form of a cylindrical collar arranged in the central space of the disc stack or bringing the gas axially downwards in the central space of the disc stack. The cylindrical collar may thus extend in the axial direction.

Moreover, the disc stack may be arranged axially under a top disc, and the collar extends axially down from the inner radius of the top disc.

Thus, such collar may form a single piece with the top disc. The stack of separation discs may be arranged between a top disc and a lower end plate. Such top disc and end plate may have a larger thickness than a single separation disc. As an example, the disc stack may be compressed between the top disc and the lower end plate.

The feature of the recesses and the guiding member for guiding the gas from the central portion of the stack to the interspaces between the discs of the stack at an axial entry position that is below the uppermost axial position of the stack both aids in preventing separated oil from re-entering the separated gas. However, it is to be understood that the feature of the guiding member may be used without the recesses and still contribute to a technical effect. Thus, in a configuration of the first aspect, there is provided a centrifugal separator for cleaning gas containing contaminants comprising
a stationary casing, enclosing a separation space through which a gas flow is permitted,
a gas inlet extending through the stationary casing and permitting supply of the gas to be cleaned,
a rotating member comprising a stack of separation discs arranged in the separation space and being arranged to rotate around an axis (X) of rotation,
a gas outlet arranged in the upper portion of the stationary casing and configured to permit discharge of cleaned gas and comprising an outlet opening through a wall of the stationary casing, wherein the gas outlet is arranged at the upper portion of the stationary casing,
a drainage outlet arranged in the lower portion of the stationary casing and configured to permit discharge of liquid contaminants separated from the gas to be cleaned;
a drive member, for rotating the rotating member;
and wherein the gas inlet is arranged to guide the gas into the central space of the disc stack axially from above, and further the centrifugal separator may comprise a guiding member for guiding the gas, liquid oil and larger aerosols from the central portion of the disc stack to the interspaces between the discs of the disc stack at an axial entry position that is below the uppermost axial position of the disc stack.

Effects and features of this configuration of the first aspect are largely analogous to those described above in connection with the first aspects above. Embodiments mentioned in relation to the first aspect above are largely compatible with this configuration of the first aspect.

As a second aspect of the invention, there is provided a method for cleaning gas containing contaminants comprising
guiding gas containing contaminants to a centrifugal separator according to the first aspect above during rotation of the rotating member,
discharging cleaned gas from the gas outlet, and
discharging contaminants from the drainage outlet.

The contaminants in the gas may comprise liquid contaminants, such as oil, and soot.

This aspect may generally present the same or corresponding advantages as the former aspect. Effects and features of this second aspect are largely analogous to those described above in connection with the first aspect. Embodiments mentioned in relation to the first aspect are largely compatible with the second aspect.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 shows a schematic drawing of a centrifugal separator for cleaning gas.

FIG. 2 shows a schematic drawing of the cross-section in the radial plane of the stationary casing.

FIG. 3a shows a close-up view of the cross-section of a single recess.

FIG. 3b shows a close-up view of the cross-section of a single recess with an adjacent rib.

FIG. 3c shows a further close-up view of the cross-section of a single recess with an adjacent rib.

FIG. 3d shows a schematic drawing of a portion of the inner side surface 4a.

FIG. 4 shows a close-up view of a portion of the centrifugal separator of FIG. 1.

### DETAILED DESCRIPTION

The centrifugal separator according to the present disclosure will be further illustrated by the following description with reference to the accompanying drawings.

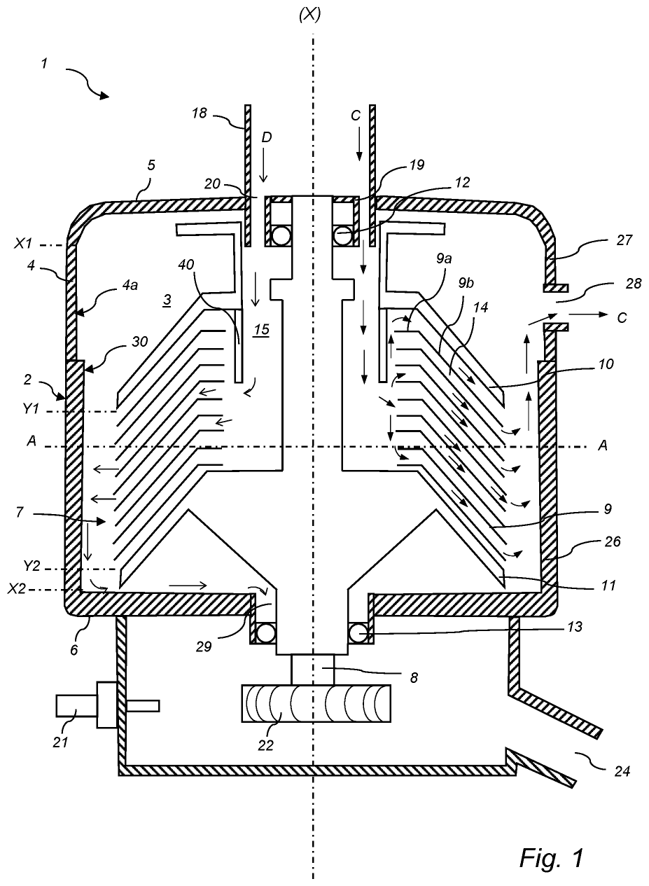

FIG. 1 shows a section of a centrifugal separator 1 according to the present disclosure. The centrifugal separator 1 comprises a stationary casing 2, which is configured to be mounted to a combustion engine (not disclosed), especially a diesel engine, at a suitable position, such as on top of the combustion engine or at the side of the combustion engine.

It is to be noted that the centrifugal separator 1 is also suitable for cleaning gases from other sources than combustion engines, for instance the environment of machine tools which frequently contains large amounts of liquid contaminants in the form of oil droplets or oil mist.

The stationary casing 2 encloses a separation space 3 through which a gas flow is permitted. The stationary casing 2 comprises, or is formed by, a surrounding side wall 4, an upper end wall 5 and a lower end wall 6

The centrifugal separator comprises a rotating member 7, which is arranged to rotate around an axis (X) of rotation. It should be noted that the stationary casing 2 is stationary in relation to the rotating member 7, and preferably in relation to the combustion engine to which it may be mounted.

The stationary casing 2 has a radius from the axis (X) of rotation to the surrounding side wall 4 that is constant at least with respect to a major part of the circumference of the surrounding side wall 4. The surrounding side wall 4 thus has a circular, or substantially, circular cross-section.

The rotating member 7 comprises a spindle 8 and a stack of separation discs 9 attached to the spindle 8. All the separation discs of the stack 9 are provided between a top disc 10 and a lower end plate 11.

The spindle 8, and thus the rotating member 7, is rotatably supported in the stationary casing 2 by means of an upper bearing 12 and a lower bearing 13, the bearings being arranged one on each side of the stack of separation discs 9. The upper bearing 12 is supported by a cap 19 which by a cylindrical part surrounds an upper end portion of the centrifugal rotor shaft, i.e. the spindle 8, the upper end portion being situated axially above the upper bearing 12. The gas inlet 20 is formed by through holes between the cap 19 and stationary inlet conduit 21, through which the inlet conduit 18 communicates with the central space 15.

The separation discs of the disc stack 9 are frusto-conical and extend outwardly and downwardly from the spindle 8. The separation discs thus comprise a flat portion 9a, which extend perpendicularly to the axis of rotation (X), and a conical portion 9b, that extend outwardly and downwardly from the flat portion 9a.

It should be noted that the separation discs also could extend outwardly and upwardly, or even radially.

The separation discs of the stack 9 are provided at a distance from each other by means of distance members (not disclosed) in order to form interspaces 14 between adjacent separation discs 9, i.e. an interspace 14 between each pair of adjacent separation discs 9. The axial thickness of each interspace 14 may e.g. be in the order of 1-2 mm.

The separation discs of the stack 9 may be made of plastic or metal. The number of separation discs in the stack 9 is normally higher than indicated in FIG. 1 and may be for instance 50 to 100 separation discs 9 depending on the size of the centrifugal separator.

The centrifugal separator 1 comprises an oil nozzle 21 arranged for being connected to an engine oil circuit of an internal combustion engine. During running of the internal combustion engine, oil is pumped through the oil nozzle 21 onto a wheel 22 connected to the spindle 8 to thereby rotate the rotating member 7 and thus the stack of separation discs 9.

As an alternative, the centrifugal separator 1 may comprise an electric motor arranged to rotate the spindle 8 and rotating member 7. As a further alternative, the centrifugal separator 3 may comprise a turbine wheel connected to the spindle 8, where the turbine wheel is arranged to be driven by exhaust gases from the internal combustion engine to rotate the spindle 8 and the rotating member 7. The rotating member 7 may also be arranged for being rotated by a mechanical drive unit. Thus, the centrifugal separator may comprise a mechanical drive unit for rotating the rotating member.

The rotating member 7 defines a central space 15. The central space 15 is formed by a through hole in each of the separation discs 9. In the embodiments of FIG. 1, the central space 15 is formed by a plurality of through holes, each extending through the top disc 10 and through each of the separation discs 9, but not through the lower end plate 11. The through holes are arranged in the flat portions 9a of the separation discs.

The gas inlet 20 is for the supply of the gas to be cleaned. The gas inlet 20 extends through the stationary casing 2, and more precisely through upper end wall 5. The gas inlet 20 communicates with the central space 15 so that the gas to be cleaned is conveyed from the inlet 20 via the central space 15 to the interspaces 14 of the stack of separation discs 9. The gas inlet 20 is configured to communicate with the crankcase of the combustion engine, or any other source, via an inlet conduit 18 permitting the supply of crankcase gas from the crankcase to the gas inlet 20 and further to the central space 15 and the interspaces 14 as explained above.

The centrifugal separator 1 comprises a drainage outlet 29 arranged in the lower portion 26 of the stationary casing 2 and configured to permit discharge of liquid contaminants separated from the gas The drainage outlet 29 is in this embodiment in the form of through holes arranged in the lower end wall 6 so that separated liquid contaminants flow through the second bearing 13 as they are drained from the separation space 3. The separated oil, and other particles and/or substances, is led to an oil outlet 24 of the centrifugal separator 1, which together with oil from the oil nozzle 21 used to drive the wheel 22, may be led back to the engine oil circuit of an internal combustion engine.

The gas outlet 28 of the centrifugal separator 1 is arranged in the upper portion 27 of the stationary casing 2 and is configured to permit discharge of cleaned gas. The gas outlet 28 comprises an outlet opening through a wall of the stationary casing 2. The gas outlet 28 is in this embodiment arranged in the upper portion of the surrounding side wall 4, but the gas outlet 28 could also be arranged e.g. in the upper end wall 5.

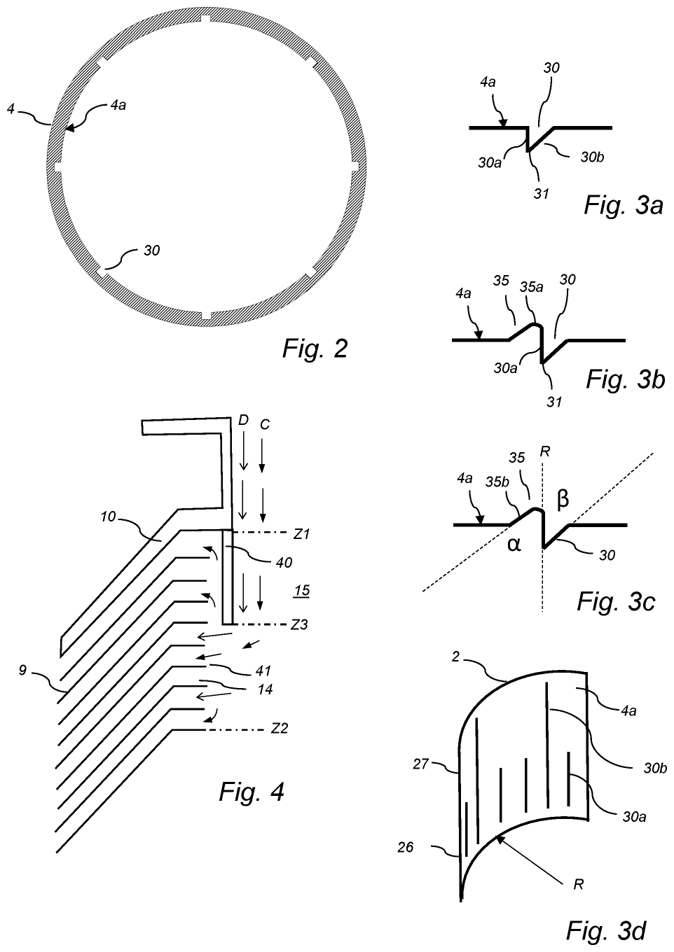

In the centrifugal separator of FIG. 1, the axial inner side surface 4a of the stationary casing 2, i.e. the inner side surface 4a of surrounding wall 4, comprises at a plurality of recesses 30 extending in the axial direction for accumulating oil that has been separated in the stack of separation discs 9. The recesses 30 are shown in more detail in FIG. 2 and in FIGS. 3a and 3b.

The recesses 30 extend axially down to the bottom of the surrounding side wall 4a. In this embodiment, the plurality of recesses extend on the inner side surface 4a from an upper axial position X1 to a lower axial position X2. The upper axial position is above the upper axial position Y1 of the radial outermost portion of the disc stack 9 whereas the lower axial position X2 is below the lowest axial position Y2 of the radial outermost portion of the disc stack 9. In this example, the axial positions X1 and X2 are such that the recesses extend throughout the whole axial length of the surrounding side wall 4, i.e. the recesses extend axially from the top to the bottom of the axial inner side surface 4a.

During operation of the centrifugal separator as shown in FIG. 1, the rotating member 17 is kept in rotation by the oil nozzle supplying oil against the wheel 22. As an example, the rotational speed may be in the range of 7.500-12.000 rpm.

Contaminated gas, e.g. crankcase gas from the crankcase of an internal combustion engine, is supplied to the gas inlet 20 via conduit 18. This gas is conducted further into the central space 15 and from there into and through the interspaces 14 between the separation discs of the stack 9. As a consequence of the rotation of the rotating member 7 the gas is brought to rotate, whereby it is pumped further on radially outwardly through gaps or interspaces 14.

During the rotation of the gas in the interspaces 14, solid or liquid particles such as oil suspended in the gas are separated therefrom. The particles settle on the insides of the conical portions 9b of the separation discs and slide or run after that radially outwardly thereon. When the particles and/or liquid drops have reached out to the radial outer edges of the separation discs 9, they are thrown away from the rotating member 7 and hit the inner surface 4a of the surrounding side wall 4. Separated oil particles may form a film on the surrounding inner surface 4a due to the rotating flow of gas, and some reach the recesses 30 of the inner wall 14a.

From there, oil may be pulled by gravity downwardly within the recesses 30 to bottom end wall 6 and then and leave the separation space 3 through the drainage outlet 29. For this, the inner wall of the bottom end wall may be tilted radially inwards, so that oil leaving the recesses may be pulled by gravity towards drainage outlet 29. The path of the contaminants in the gas is schematically illustrated by arrows “D” in FIG. 1.

Cleaned gas freed from particles and exiting from the stack of separation discs 9 leaves the stationary casing 2 through the gas outlet 28. The path of the gas through the centrifugal separator 1 is schematically shown by arrows “C” in FIG. 1. The gas is more evenly distributed in the stack of separation discs 9 as compared to the contaminants. This is further discussed in relation to FIG. 4 below.

FIG. 2 shows the cross-section in the radial plane of the stationary casing 2 along line “A” in FIG. 1. Thus, FIG. 2 shows the cross-section of the surrounding wall 4 of the stationary casing 2. As illustrated in FIG. 2, the plurality of recesses 30 are distributed evenly on the inner side surface 4a around the inner side wall 4. In this embodiment, there are eight recesses in the inner wall 4a, and each recess 30 has a rectangular cross section as seen in the radial. Thus, the “hole” made by the actual recess 30 is in the form of a rectangular prism extending in the vertical direction. The total inner area of the recesses is much lower than the total inner area of the inner side surface 4a. As an example, the inner area of the plurality of recesses 30 may be less than half of the area, such as less than 25%, such as less than 10% of the total axial inner side surface 4a of the stationary casing 2.

As also illustrated in FIG. 2, the axial inner surface 4a of the stationary casing 2 may be substantially flat apart from the at least one recess.

FIG. 3a shows an alternative embodiment of the shape of a recess 30 in which the cross-section has a triangular shape in the radial plane. The recess 30 has a tip-shaped cross-section such that the cross-section tapers from a radial inner position to a radial outer position. Thus, the “tip” 31 as seen in the radial plane is arranged at a radial outermost position of the triangular cross-section. The tip 31 is shifted from the center of the cross-section. Thus, the recess 30 is formed by a first radial recess surface 30a extending from the inner side surface 4a of the stationary casing 2 and a second recess surface 30b forming an angle with the radial direction. The “tip” 31 of the triangular cross section is thus where these first and second recess surfaces meet at the radially innermost position of the cross-section.

The inner side surface 4a may also comprise axial ribs 35 extending axially alongside the recesses 30. The rib 35 forms a protrusion of the inner side surface 4a and there may be one rib 35 for each recess 30 extending along an axial side of the recess 30. An example of a rib 35 and recess is illustrated in FIG. 3b, which shows the cross-section in the radial plane of a rib 35 and a recess 30. In this example, the rib 35 has its rib peak 35a shifted against the direction of the recess 30. The rib 35 and recess 30 forms a Z-shaped cross-section in the radial plane. This is due to the radial recess surface 30a also forming part of the surface forming the rib or protrusion 35. Thus, as seen in the radial cross-section, the radial recess surface extends from the tip 31 of the recess to the peak 35a of the rib.

Thus, the first radial recess surface 30a extends out from the axial inner side surface 4a and form a portion of the rib 35 that is arranged alongside the at least one recess 30.

As illustrated in FIG. 3b, the second recess surface 30b forms an angle β with the radial direction R. This angle β may for example be between 0-75 degrees. Further, angle β may be constant for all recesses 30 on the inner surface 4a. However, the angle β may also vary between recesses 30 on the inner surface 4a.

In analogy, the rib surface 35b may form an angle α with the radial direction R. This angle α may for example be between 0-75 degrees. Further, angle α may be constant for all ribs 35 on the inner surface 4a. However, the angle α may also vary between ribs 35a on the inner surface 4a.

The centrifugal separator 1 may comprise recesses 30 and/or recesses 30 with corresponding ribs 35 of different axial length. This is illustrated in FIG. 3d, which shows a schematic illustration of a part of the axial inner side surface 4a of the stationary casing 2. The

In embodiments, the angle α is substantially equal to angle β for all ribs 35 and adjacent recesses 30 on the inner surface 4a of the stationary casing 4. The inner side surface 4a comprises a first set 30a of recesses 30 extending only in the axial lower portion 26 of the axial inner surface 4a of the stationary casing 2 as well as a second set 30b of recesses 30 extending in both an axial lower portion 26 and an axial upper portion 27 of the stationary casing 2. This may be an advantage if e.g. more contaminants such as oil is separated out to the lower portion 26 of the axial inner surface 4a.

Apart from the above-described ribs 35 and the recesses 30, the inner side surface 4a may be substantially flat.

FIG. 4 shows a close-up view of on side of the centrifugal separator 1 of FIG. 1 and how gas to be cleaned is led into the central space 15, as indicated by arrows “C” (gas) and “D” (contaminants including liquid oil and/or larger aerosols). The centrifugal separator 1 also comprises a guiding member 40 in the form of a cylindrical collar that is attached to the top disc 10. This collar 40 is arranged for guiding gas, as well as liquid oil and larger aerosols, from the central portion 15 of the disc stack 9 to the interspaces 14 between the discs of the disc stack 9 at an axial entry position Z3 that is below the uppermost axial position Z2 of the disc stack 9. Thus, the central space 15 may extend from the inner circumference 41 of the uppermost disc at an axial position Z1 down to the inner circumference 41 of the lowermost disc at an axial position Z1. By the use of the cylindrical collar 40 extending down into central space 15, the axial entry position is provided somewhere between Z1 and Z2, depending on the axial length of collar 40. Asan example, the axial length of the collar 40 may be such that the axial entry position is below the upper 25% of the total axial length, i.e. the axial length between Z1 and Z2, of the disc stack. Such “mid-stack entry” of the gas aids in preventing separated liquid from re-entering cleaned gas at the gas outlet 28 arranged in the upper portion 27 of the casing 2, since fewer liquid contaminants is separated and thrown against the inner side wall 4a from the upper portions of the disc stack 9.

As illustrated in FIG. 4, the gas, as indicated by arrows “C” are more evenly distributed axially throughout the stack of separation discs 9 even with the presence of the collar 40, whereas liquid oil is guided in a middle and lower axial portion of the stack of separation discs 90 by the use of the collar 40, as indicated by arrows “D”. This may thus facilitate for separated oil to hit a lower axial portion of the inner wall 4a of the stationary casing 2, and thereby reduce the risk of separated oil to re-enter the clean gas that is discharged through the gas outlet 28 at an axial upper portion of the stationary casing 2.

The invention is not limited to the embodiment disclosed but may be varied and modified within the scope of the claims set out below. The invention is not limited to the orientation of the axis of rotation (X) disclosed in the figures. The term “centrifugal separator” also comprises centrifugal separators with a substantially horizontally oriented axis of rotation. In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A centrifugal separator for cleaning gas containing contaminants comprising:
a stationary casing, enclosing a separation space through which a gas flow is permitted;
a gas inlet extending through the stationary casing and permitting supply of the gas to be cleaned;
a rotating member comprising a plurality of separation members arranged in said separation space and being arranged to rotate around an axis of rotation,
a gas outlet arranged in an upper portion of the stationary casing and configured to permit discharge of cleaned gas and comprising an outlet opening through a wall of the stationary casing;
a drainage outlet arranged in a lower portion of the stationary casing and configured to permit discharge of liquid contaminants separated from the gas to be cleaned; and
a drive member for rotating the rotating member,
wherein an axial inner side surface of the stationary casing comprises at least one straight recess extending in an axial direction for accumulating oil that has been separated in said plurality of separation members,
wherein said at least one recess comprises a first radial recess surface extending from the axial inner side surface of the stationary casing, and
wherein said at least one recess extends axially on the inner side surface at least along an axial length of a radially outermost portion of said separation plurality of members.

2. The centrifugal separator according to claim 1, wherein the axial inner side surface comprises at least one rib extending axially alongside said at least one recess.

3. The centrifugal separator according to claim 2, wherein said at least one rib extends axially adjacent to said first radial recess surface.

4. The centrifugal separator according to claim 3, wherein the first radial recess surface also forms a portion of the at least one rib.

5. The centrifugal separator according to claim 1, wherein an inner area of the at least one recess is less than half of an area of a total axial inner side surface of the stationary casing.

6. The centrifugal separator according to claim 1, wherein the axial inner side surface of the stationary casing comprises at least three recesses.

7. The centrifugal separator according to claim 1, wherein said at least one recess extends axially down to a bottom of the stationary casing.

8. The centrifugal separator according to claim 1, wherein the plurality of separation members is a stack of separation discs.

9. The centrifugal separator according to claim 1, wherein the at least one recess extends along a whole axial length of the axial inner side surface.

10. The centrifugal separator according to claim 1, wherein said at least one recess has a tip-shaped cross-section as seen in a radial plane such that the cross-section of the recess tapers from a radial inner position to a radial outer position.

11. The centrifugal separator according to claim 10, wherein said tip-shaped cross-section of the recess is formed by said first radial recess surface extending from the axial inner side surface of the stationary casing and a second recess surface forming an angle with a radial direction.

12. The centrifugal separator according to claim 3, wherein said at least one rib and an adjacent of said at least one recess form a Z-shaped cross-section in a radial plane.

13. The centrifugal separator according to claim 1, wherein the gas inlet is arranged at the upper portion of the stationary casing.

14. The centrifugal separator according to claim 13, wherein the plurality of separation members is a stack of separation discs, and wherein the gas inlet is arranged to guide the gas into a central space of the stack of separation discs axially from above, and wherein said centrifugal separator comprises a guiding member for guiding the gas, liquid oil and larger aerosols from the central space of the disc stack to interspaces between the discs of the disc stack at an axial entry position that is below an uppermost axial position of the disc stack.

15. The centrifugal separator according to claim 14, wherein the guiding member is arranged to guide the gas at an axial entry position that is below an upper 25% of a total axial length of the disc stack.

16. The centrifugal separator according to claim 14, wherein the guiding member is in the form of a cylindrical collar arranged in the central space of the disc stack for bringing the gas axially downwards in the central space of the disc stack.

17. The centrifugal separator according to claim 16, wherein said disc stack is arranged axially under a top disc and said collar extends axially down from an inner radius of said top disc.

18. The centrifugal separator according to claim 1, wherein the axial inner side surface of the stationary casing comprises at least five recesses.

19. The centrifugal separator according to claim 2, wherein an inner area of the at least one recess is less than half of an area of a total axial inner side surface of the stationary casing.

20. The centrifugal separator according to claim 3, wherein an inner area of the at least one recess is less than half of an area of a total axial inner side surface of the stationary casing.
